(19) United States
(12) Patent Application Publication
(10) Pub. No.: US 2017/0323480 A1
(43) Pub. Date: Nov. 9, 2017

(54) Visualization Technique for Ground-Penetrating Radar

(71) Applicant: US Radar, Inc., Matawan, NJ (US)

(72) Inventors: Justin LaBarca, Matawan, NJ (US); Matthew Keys, West Windsor, NJ (US)

(21) Appl. No.: 15/222,255

(22) Filed: Jul. 28, 2016

Related U.S. Application Data
(60) Provisional application No. 62/332,170, filed on May 5, 2016.

(51) Int. Cl. G06T 19/00; G06F 3/00; G01S 13/88

(52) U.S. Cl. CPC G06T 19/006; G01S 13/885; G06F 3/005

(57) ABSTRACT

Ground-penetrating radar (GPR) technology enables the detection of hidden objects that are underground or behind walls or other such surfaces. Embodiments of the present invention provide a realistic visualization of the hidden objects through so-called augmented reality techniques. Thanks to such visualization, interaction with hidden objects that are hazardous or delicate is easier and less prone to errors. Also, GPR-based data collection can be performed in non-real time, with object visualization occurring at a later time based on stored data that can also comprise annotations. This capability provides greater flexibility for scheduling activities related to the hidden objects.

### CROSS REFERENCE TO RELATED APPLICATIONS

This case claims benefit of the following provisional application:

(1) U.S. provisional application No. 62/332,170.

### FIELD OF THE INVENTION

The present invention relates to ground-penetrating radar systems and, more particularly, it relates to visualization techniques for depicting the data collected by such systems.

### BACKGROUND

Ground Penetrating Radar (GPR) is a technology for detecting underground objects. A GPR system typically comprises a transmitter that transmits a radio signal into the ground and a receiver. Underground objects reflect the signal, and the receiver can detect the reflected signals. The strength and timing of the reflected signals convey information about the size and depth of the underground objects. Other parameters of the objects can also be derived from the reflected signals.

GPR technology is used more broadly than just for detecting underground objects. The same equipment and techniques are also suitable, perhaps with some simple modifications, for detecting objects hidden behind a surface. For example, GPR techniques are commonly used for detecting objects below a floor or embedded in or behind a wall or ceiling.

GPR technology is particularly useful, for example, in the construction business whenever there is a need for remodeling an existing structure. It is often the case that it is not known what objects might be present inside, for example, a concrete pillar or a wall, or ceiling. Such objects might be metal objects that could cause damage to demolition equipment or, worse, they might be live electrical wires or pipes that might present a life-threatening hazard to construction crews if accidentally damaged. In all such cases, GPR equipment can be used for detecting objects and hazards. GPR is also used for verification of new construction and with a variety of surfaces and materials. Examples of structures and materials that are examined via GPR include, in additions to those already mentioned, bridges, tunnels, trees, poles, beams and other structures made of wood, concrete, masonry, natural or artificial materials, etc., to name just a few. For the purposes of this specification, the words “ground penetrating radar” and the abbreviation “GPR” should be understood to include all cases where GPR technology is used even though the medium being penetrated is not, strictly speaking, ground.

Ultimately, the objective of a GPR system is to enable a human operator to learn what objects are present behind the surface being examined. To that end, a GPR system must convert the detected signals into a format suitable for human consumption. Usually, the signals are converted into a visual image displayed on a screen such as a computer screen.

Many formats have been devised for how to visualize detected GPR signal data. For example, the screen might depict a cross section of the ground below a GPR system wherein color coding and/or varying image brightness convey information about the position, size, and other features of hidden objects.

A skilled GPR operator can use such depictions to identify where, behind the surface, a particular object is, and to learn, for example, the size and shape of the object.

A common use of GPR technology might be, for example, to identify underground objects to be avoided when digging with a backhoe. A skilled GPR operator can monitor the digging and direct the backhoe operator to dig in a particular place instead of another, so as to avoid damaging a particular underground object such as, for example, a gas pipe.

The better the visual depiction provided by the GPR system, the easier it will be for the skilled GPR operator to accurately pinpoint the position and size of underground objects. A better depiction reduces the skill level required of the GPR operator, and reduces the risk of mistakes in identifying where to dig and where not to dig.

It would be very advantageous to have a GPR system with a depiction technique so effective and easy to interpret that little or no special skills are needed. Such a system might be used, for example, by the backhoe operator directly and without requiring the presence and interpretation provided by a skilled GPR operator.

### SUMMARY

Some embodiments of the present invention enable a human viewer to visualize hidden objects detected by a GPR system. The visualization is more realistic than prior-art visualization techniques. As such, it makes it easier for the viewer to perform tasks related to the hidden objects. Other embodiments of the present invention provide guidance for an operator of a GPR system whose task is to move a GPR unit along a desired path.

Embodiments of the present invention comprise a display system that generates a realistic image of the environment where a GPR unit is operated. For example, in some embodiments, the display system is a head-mounted display unit such as those used for so-called virtual reality or augmented reality depictions. The display system reproduces the natural visual experience of the surroundings. In some embodiments, the display system achieves this result by comprising conventional transparent eyeglasses such that the surrounding environment is directly visible. In all embodiments, the display system is capable of adding computer-generated images superimposed on the natural image of the surroundings.

Embodiments of the present invention comprise the ability to estimate the position of the GPR unit relative to the surrounding environment. The position and orientation of underground objects are detected via processing of radio signals transmitted by the GPR unit and reflected by the objects. Based on such data, a visualization system generates images of the objects wherein the objects have the correct sizes, positions, and orientations relative to the surrounding environment. Finally, the display system presents visible images of the objects to a human viewer. The images are superimposed on an image of the surrounding environment such that the images of the objects are visible in their correct size, position and orientation. The human viewer perceives the ground as if it were transparent, such that the objects below are now visible.

### BRIEF DESCRIPTION OF THE DRAWINGS

FIG. 1a depicts an implementation of Ground Penetrating Radar (GPR) technology in the prior art.

FIG. 1b depicts a prior-art GPR unit transmitting a radio signal into the ground.

FIG. 1c depicts a prior-art GPR unit receiving a radio signal reflected by an underground object.

FIG. 2 is a block diagram of a GPR unit in the prior art.

FIG. 3 is a block diagram of a system for visually depicting underground objects in accordance with an illustrative embodiment of the present invention.

FIG. 4 depicts an example of an embodiment of the present invention being used by a human operator.

FIG. 5 depicts a typical use of GPR technology at a construction site in the prior art.

FIG. 6 depicts an example of an embodiment of the present invention being used at a construction site.

FIG. 7 depicts an example of a system for remote evaluation of GPR data in real time in accordance with an alternative illustrative embodiment of the present invention.

FIG. 8 depicts an example of an improved system for remote evaluation of GPR data in real time in accordance with an alternative illustrative embodiment of the present invention.

FIG. 9 depicts an example of another system for remote evaluation of GPR data in non-real time in accordance with an alternative illustrative embodiment of the present invention.

FIG. 10 depicts an example of another improved system for remote evaluation of GPR data in non-real time in accordance with an alternative illustrative embodiment of the present invention.

FIG. 11 depicts an example of how underground are visualized for a construction worker in accordance with some embodiments of the present invention.

### DETAILED DESCRIPTION

The technology of so-called “augmented reality” is a technology that superimposes computer-generated images on a user's view of the real world, thus providing a composite view. Such a composite view can be viewed, for example, via a conventional computer screen, which generates images electronically. A conventional camera might be used for capturing an image of an environment, for the image to be then displayed on the computer screen along with the computer-generated images. This might occur in real time, wherein the image of the environment is a live image, or in non-real time, wherein the image of the environment is a stored image captured at an earlier time. With augmented reality, the computer-generated images might be themselves actual images of real objects captured with a camera, or artificial software-generated images, or graphics, or other types of computer-generated images, or a combination of different types of images. For example, in the composite view a viewer might see objects or people that were not actually present when the image of the environment was captured, or the viewer might see graphics providing information or guidance.

An objective of augmented reality is to make the composite view appear as realistic as possible. An important technology for achieving this objective is provided by head-mounted binocular display units. Such units comprise a pair of electronic displays, one for each eye, such that the two eyes of the viewer can be shown two different images, as occurs with normal binocular vision. Furthermore, such units frequently comprise technology for detecting the instantaneous orientation and position of the viewer's head. Through computer processing, the two displayed images are modified in real time, as the viewer moves his/her head, such that the viewer perceives the images as very realistic images of a real-looking environment in which the viewer has freedom to move as desired.

In some implementations of head-mounted display units, the actual surrounding environment is completely blocked from view, and the viewer sees only the images presented by the two electronic displays for the two eyes. In such implementations, the computer driving the display unit must provide the images of the environment on which the computer-generated images are superimposed. As mentioned above, the images of the environment can be captured via a camera. For a head-mounted display unit that provides binocular images, a binocular (aka stereoscopic) camera is preferred.

In other implementations of head-mounted display units, the surrounding environment is directly visible; for example, a head-mounted display unit might comprise a pair of conventional transparent eyeglasses or goggles through which the viewer sees the actual surrounding environment. The transparent eyeglasses or goggles can be made of glass, transparent plastic, transparent acrylic material, or some other transparent material. To achieve the desired augmented-reality effect, such head-mounted display units can superimpose computer-generated images on the actual images of the surrounding environment. For example, they might project the computer-generated images on the surface of the transparent material. Such display units are desirable, in some applications, because the images of the environment are likely to be more realistic than when they are generated electronically and viewed with electronic displays such as conventional computer screens or monitors, or with the types of head-mounted display units described in the previous paragraphs.

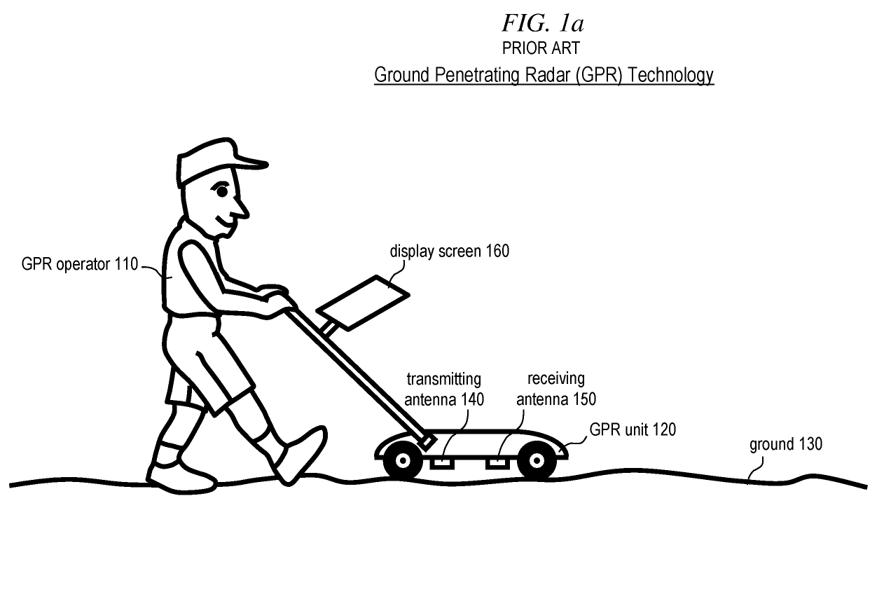

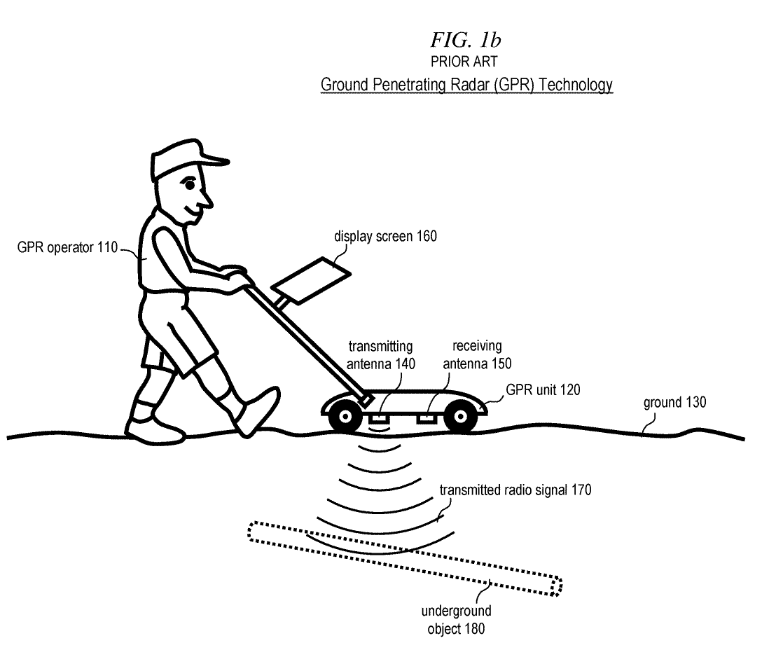

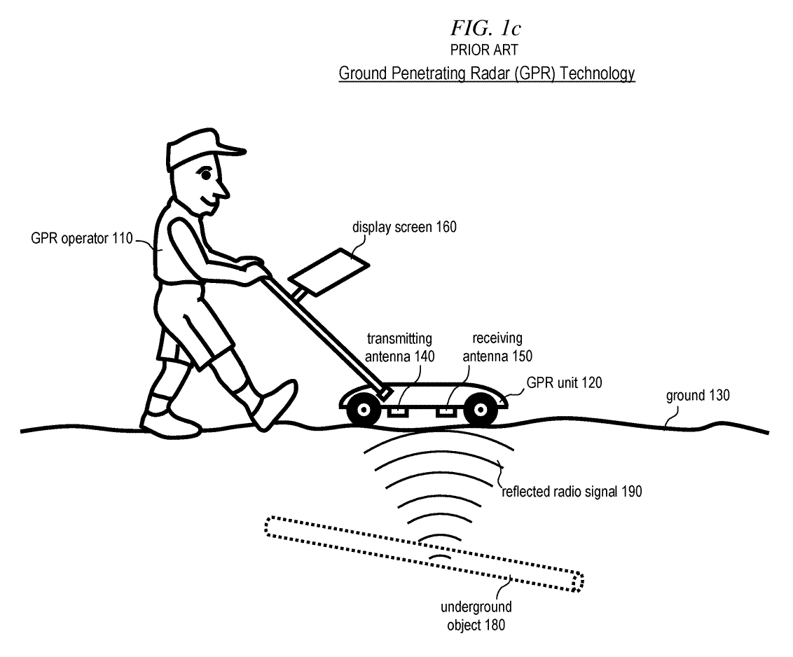

FIG. 1a depicts an implementation of Ground Penetrating Radar (GPR) technology in the prior art. In the figure, GPR operator 110 pushes a GPR unit 120. The GPR unit is in the shape of a wheeled cart that can be easily pushed by a human operator along a path on the ground 130. The GPR unit comprises a transmitting antenna 140 for transmitting a radio signal into the ground, and a receiving antenna 150 for receiving radio signals from the ground. The GPR unit also comprises display screen 160 for displaying a processed version of the data collected by the GPR unit.

FIG. 1b depicts what happens when transmitting antenna 140 transmits a radio signal into the ground. The radio signal is depicted as transmitted radio signal 170. The radio signal propagates through the ground and may encounter underground objects such as the underground object 180 depicted in the figure. In the figure, underground object 180 might be, for example, a buried metal pipe. Many underground objects are made of materials, such as metal, that reflect radio signals differently from other underground materials.

FIG. 1c depicts what happens after transmitted radio signal 170 encounters underground object 180. Some of the radio signal is reflected by the object. The reflected signal is depicted as reflected radio signal 190. The reflected radio signal propagates through the ground and some of it is received by receiving antenna 150. Characteristics of the reflected signal such as strength, timing, phase, power spectrum, and others depend on characteristics of the reflecting object such as size, shape, position orientation, material, and others. Such characteristics of the reflecting object can be estimated from the portion of the reflected signal that is received by receiving antenna 150.

GPR unit 120 comprises a signal processor for processing the reflected radio signal, as received by received by the receiving antenna. The signal processor processes the received radio signal, and generates a visualization of the received radio signal to be displayed on display screen 160. In the prior art, a variety of visualization techniques have been developed for enabling GPR operator 110 to assess the size, position, and other characteristics of underground objects in real time, while he/she is pushing the GPR unit cart on the ground. Generally, such visualization techniques are based on depicting a cross section of the ground below the cart, wherein the depiction includes representations of characteristics of reflected signals. A skilled GPR operator is able to infer the characteristics and position of underground objects from such depictions.

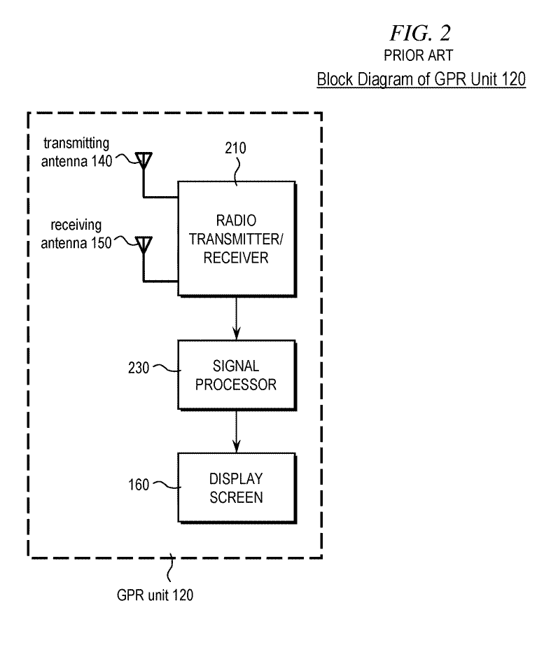

FIG. 2 is a block diagram of GPR unit 120. Radio transmitter/receiver 210 generates a radio signal to be transmitted through transmitting antenna 140, and receives any reflected signals through receiving antenna 150. The signal processor mentioned in the previous paragraph is depicted here as signal processor 230; it processes the received radio signal, and generates a visualization of the received radio signal to be displayed on display screen 160.

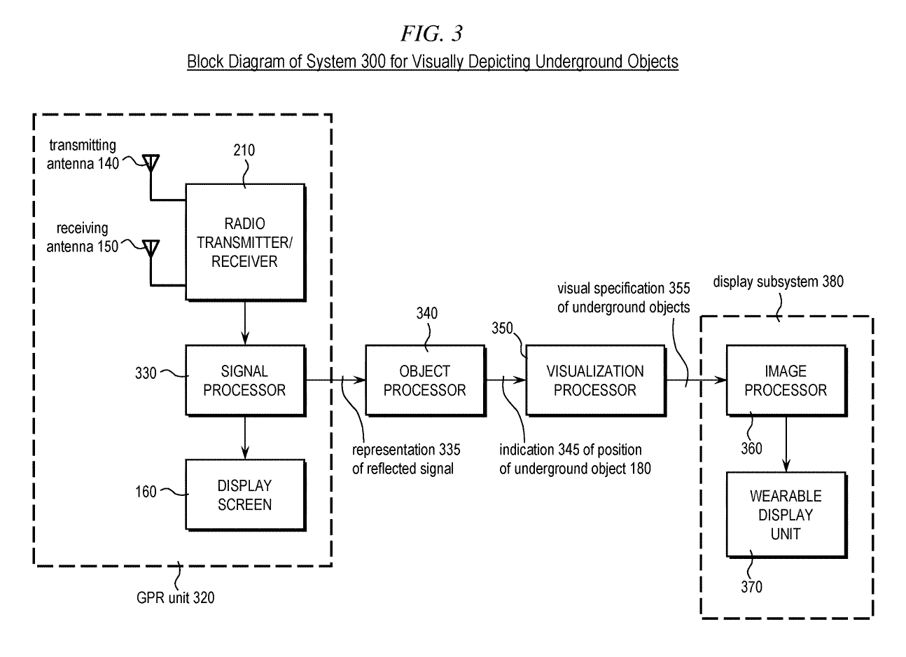

FIG. 3 is a block diagram of an illustrative embodiment of the present invention: system 300 for visually depicting underground objects comprises a GPR unit 320 that is similar to GPR unit 120, except for the signal processor 330 whose functionality is different from the functionality of signal processor 230. When used in the environment depicted by FIGS. 1a through 1c, signal processor 330 generates a representation 335 of reflected signal 190 suitable for extracting one or more characteristic of the underground object 180 that reflected the signal. For example and without limitation, representation 335 can comprise one or more characteristics of the reflected signal that are estimated from the signal received by receiving antenna 150. In some alternative embodiments of the present invention, representation 335 comprises one or more sampled waveforms of one or more signals derived from signals received by receiving antenna 150.

Based on representation 335, object processor 340 generates a description of the underground object 180 that comprises an indication 345 of the object's position. In some alternative embodiments of the present invention, the description also comprises additional characteristics of the object that can be derived from the reflected signal such as, for example, the object's size, shape, orientation, density, texture, etc.

Based on indication 345, visualization processor 350 generates a visual specification 355 of the underground object 180 that specifies how the object is disposed relative to the surrounding environment. In other words, it specifies where an image of the object should appear relative to other objects in the surrounding environment. For example, such other objects in the environment might include plants, trees, rocks, structures, ground features, the GPR unit 320 itself, and even the GPR operator 110. The visual specification provides the necessary information to allow image processor 360 to create a composite image of the environment that also includes an image of the object in its correct position relative to the environment. Finally, the composite image is presented to the GPR operator via a wearable display unit 370. In some embodiments, wearable display unit 370 is a head mounted display unit.

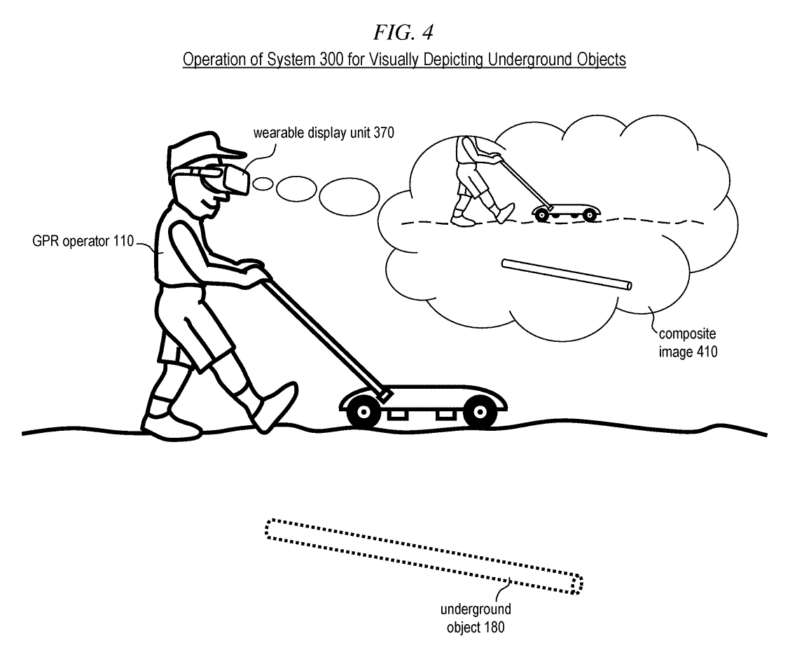

FIG. 4 depicts GPR operator 110 as he/she uses a system in accordance with this illustrative embodiment of the present invention. GPR operator 110 is wearing wearable display unit 370, through which he/she is able to see the surrounding environment in a natural way. For example, in some embodiments, wearable display unit 370 includes cameras that capture exactly the images that the eyes of GPR operator would see if he/she were not wearing the wearable display unit. Those images can be displayed unaltered by the display unit. Thanks to those images, the GPR operator is still able to push the GPR unit cart as needed, and he/she is also able to interact with the environment effectively, as if he/she were not wearing the display unit.

However, the image displayed by wearable display unit 370 is a composite image that, in addition to showing the environment, also shows an image of the underground object exactly where the object is relative to the environment. FIG. 4 depicts the composite image seen by the GPR operator as composite image 410. In the composite image, the ground is shown as partially transparent, such that the underground object is clearly visible to the GPR operator below the ground at its correct position under the GPR cart.

Although wearable display unit 370 is depicted as completely covering the eyes of the GPR operator, such that the operator is unable to directly see the surrounding environment, it will be clear to those skilled in the art, after reading this disclosure, how to make and use embodiments of the present invention wherein the wearable display unit is of a different type. For example and without limitation, the wearable display unit might be of the type wherein the environment is directly visible, as discussed in a previous paragraph.

Although this illustrative embodiment of the present invention comprises a wearable display unit, it will be clear to those skilled in the art, after reading this disclosure, how to make and use embodiments of the present invention wherein a non-wearable display unit is used. For example and without limitation, in some embodiments, the display unit is a conventional computer monitor. For example, a display unit similar to display screen 160 can be used. In some alternative embodiments, a handheld or portable unit such as a tablet or a smartphone or a laptop computer is used as a display unit. In some of such embodiments, a camera is used to capture the image of the environment to be displayed on the display unit as part of the composite image. If the camera is mounted near or on the display unit, the composite image is likely to look more natural to the viewer.

In FIG. 3, the block diagram of GPR unit 320 is shown as comprising a display screen 160, similar to GPR unit 120. However, it will be clear to those skilled in the art that display screen 160 might not be necessary because of the availability of wearable display unit 370 for providing visual information to the GPR operator. Therefore, in embodiments of the present invention, display screen 160 might or might not be present.

In FIG. 3, image processor 360 and wearable display unit 370 are collectively identified as display subsystem 380. Furthermore, visualization processor 350, object processor 340, signal processor 330, and other blocks, are depicted as distinct blocks that are realized, in some embodiments, as distinct processors and hardware. However, it will be clear to those skilled in the art, after reading this disclosure, how to make and use embodiments of the present invention wherein two or more of the blocks are not realized as distinct entities. For example and without limitation, in some other embodiments, the functionality of any combination of blocks can be realized by a single entity with or without distinct processors for the various functions. In some embodiments, some functions are performed by hardware that is physically located in one component of the overall system, while in other embodiments the same functions are performed by hardware that is physically located in a different component of the system. For example and without limitation, several of the functions can be performed by one or more processors located inside the wearable display unit 370 or inside the GPR unit 320. In some further embodiments, some functions are performed by remote hardware.

Although FIG. 4 depicts the wearable display unit 370 as being worn by the GPR operator, it will be clear to those skilled in the art, after reading this disclosure, how to make and use embodiments of the present invention wherein another person wears the wearable display unit. In some embodiments, multiple people, each using a different display unit, are able to simultaneously view composite images that show underground objects. For example and without limitation, one or more experts other than the GPR operator might want to monitor the operation of the system. In such embodiments with multiple viewers, it might be desirable that each viewer see a personally customized composite image with the correct view of the environment that each viewer would naturally see. Alternatively, in embodiments where reduced complexity is desired, multiple viewers can all see the same composite image.

It twill also be clear to those skilled in the art, after reading this disclosure, how to make and use embodiments of the present invention wherein some or all of the viewers are remotely located. In such embodiments, one or more of the links shown as arrows in FIG. 3 are be implemented as long-distance communication links.

Although the links between blocks in FIG. 3 are shown as arrows without an explicit indication of how they might be implemented, it will be clear to those skilled in the art, after reading this disclosure, how to make and use embodiments of the present invention wherein one or more of those links are implemented as wireless links. For example and without limitation, in the depiction of FIG. 4, no wires are depicted connecting wearable display unit 370 to the GPR unit cart. In the embodiment depicted in FIG. 4, at least one of the links should be a wireless link in order to implement the embodiment as depicted.

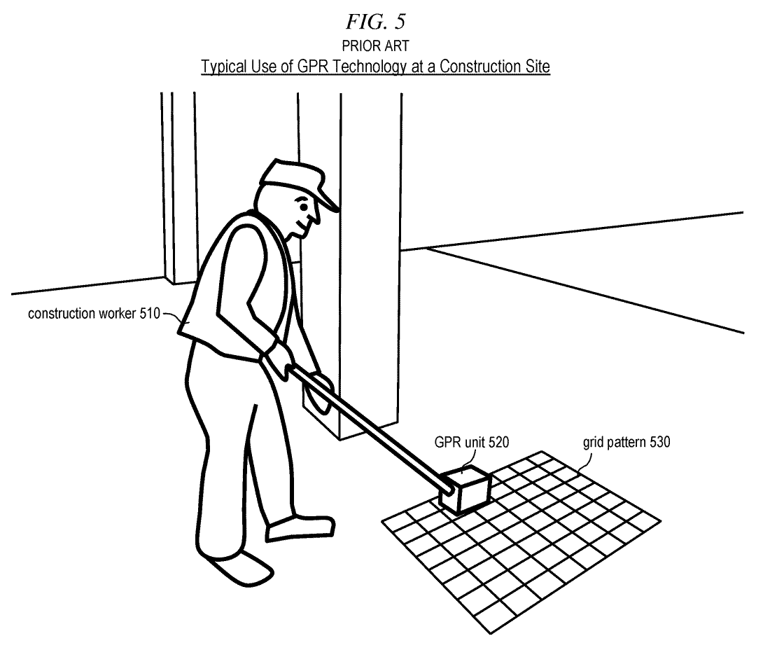

FIG. 5 depicts a typical example of how GPR technology in the prior art might be used on a construction site. In the example of FIG. 5, a construction worker 510 uses a GPR unit 520 to look for possible hazards such as gas pipes or electrical wiring buried inside a concrete floor prior to commencing demolition work on the floor. In order to obtain an accurate estimate of the position of detected objects, it is customary to draw a grid pattern on the floor. The grid pattern is depicted as grid pattern 530 in the figure. The grid pattern is also helpful for the construction worker to keep track of which areas have and have not already been examined; however, the risk of error remains, and having to draw the pattern is time consuming and inconvenient, especially in situations where damage to the floor might occur because of the drawing. Damage to the floor can be avoided by drawing the pattern on a mat that is laid on the floor, but this makes the grid less permanent and increases the risk of errors caused by the mat being accidentally moved.

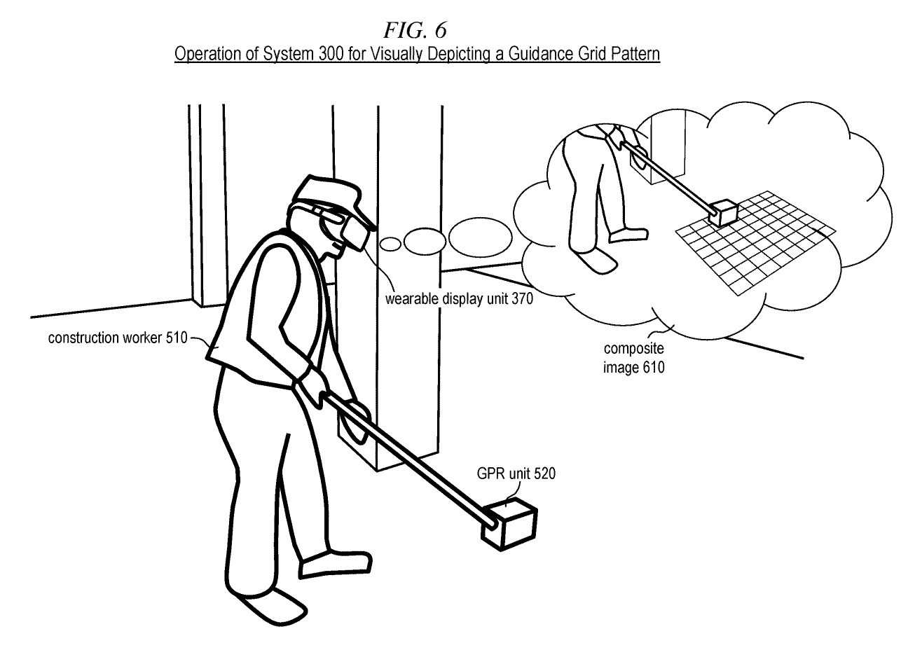

FIG. 6 depicts construction worker 510 as he/she uses a system in accordance with an alternative illustrative embodiment of the present invention. Construction worker 510 is wearing wearable display unit 370, through which he/she is able to see the surrounding environment in a natural way. No grid pattern has been drawn on the floor; however, the construction worker sees a familiar grid pattern on the floor because the visualization processor 350 has been adapted to superimpose an image of the grid pattern on the floor, in the desired spot, in the composite image displayed by wearable display unit 370. FIG. 6 depicts the composite image seen by the GPR operator as composite image 610.

In some embodiments of the present invention, wearable display unit 370 comprises, for example, a camera for capturing an image of GPR unit 520 as it is moved along a prescribed path. For example, the path can be defined by the grid pattern. In such embodiments, the picture captured by the camera can be processed for the purpose of keeping track of the path followed by the GPR unit. Portions of the path that the GPR unit has already covered can be displayed in a particular color in the composite image, while portions of the path not yet covered can be displayed in a different color. Such a differential color display is advantageous for insuring that no portions of the prescribed path are accidentally skipped.

It will be clear to those skilled in the art, after reading this disclosure, how to make and use embodiments of the present invention that use other methods for keeping track of the path followed by the GPR unit. For example and without limitation, a localization system can be used to generate estimates of the position of the GPR unit as it is moved on the surface of the floor. Such estimates should preferably be relative to a reference frame that can be related to the surrounding environment. Several options are available. For example and without limitation, in some embodiments, the reference frame is a system of navigation satellites, such as the so-called GPS satellite system, wherein the satellites transmit reference radio signals; such systems are collectively known as global navigation satellite systems (GNSS). In some further embodiments, the localization system is based on some other form of radiolocation wherein the reference frame is provided by one or more reference radio transmitters of a radio-signal. For indoor applications, sound- or ultrasound-based localization systems can also be used.

Image processing of the surrounding environment can support several other alternative implementations of a localization system. For example and without limitation, in some embodiments, visual markers are placed at reference points in the environment. Such markers can be, for example, so-called augmented-reality markers. In some situations, the visual markers are already present in the environment, whereas in other situations, they are placed in the environment by an operator when needed. With some embodiments of the present invention that do not provide the capability illustrated by FIG. 6, an actual grid pattern is placed on the surface being examined, as is customary to do with GPR systems; in such embodiments, the grid pattern can be used as a reference frame for localization. In an environment that is sufficiently rich with suitable features, embodiments are possible that avoid having to place markers of any type because it is possible to use features that are naturally occurring in the environment to establish a reference frame. For example, if a floor, or pavement, or ground exhibits a pattern of cracks, or bumps, or pebbles, or decorations, or other such features, pattern recognition via image processing can be sufficient to provide a reliable reference frame. Also, objects in the environment such as, for example, trees, rocks, plants, etc., in an outdoor environment, or walls, windows, structures, in an indoor environment, can provide enough patterns to yield a usable reference frame via image processing.

Pattern recognition via image processing is advantageous for providing a reference frame because, as discussed, embodiments of the present invention are likely to already have one or more cameras that capture images of the surrounding environment. It will be clear to those skilled in the art, after reading this disclosure, how to make and use embodiments of the present invention that take advantage of image processing for establishing a suitable reference frame based on existing features of an environment.

In the foregoing paragraphs, illustrative embodiments of the present invention have been presented as applicable to GPR systems for detecting objects underground or embedded in a floor; however, GPR systems are also applicable for detecting objects hidden behind a variety of other surfaces. For example and without limitation, GPR systems are often used to examine things such walls, ceilings, etc., and structures such as bridges, tunnels, trees, poles, beams and other structures made of wood, concrete, masonry, natural or artificial materials, etc., to name just a few. It will be clear to those skilled in the art, after reading this disclosure, that embodiments of the present invention are possible whenever a GPR system is used to detect something hidden behind a surface, even if the something is not necessarily a physical object, as GPR systems are also used to detect, for example and without limitation, voids, or defects, or texture changes in a variety of materials and situations.

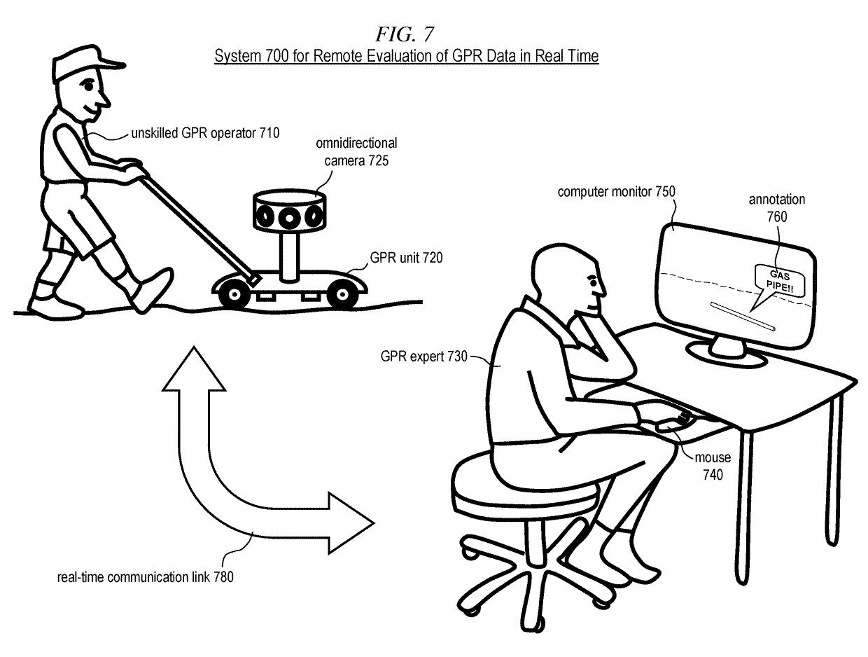

FIG. 7 depicts an illustrative embodiment of the present invention wherein the GPR unit is operated by an unskilled GPR operator 710. Data collected by the GPR unit are communicated, in real time, to a GPR expert 730 that is located remotely, relative to the site where the GPR unit is operated. In the figure, GPR expert 730 is depicted as sitting at a desk in an office. The GPR expert views the operation of the GPR unit via a computer monitor 750.

Several variants of this illustrative embodiment, as depicted in FIG. 7, are possible. In particular, the data communicated by the GPR unit to the GPR expert can comprise, for example and without limitation, the representation 335 of one or more reflected signals, or the indication 345 of the position of one or more underground objects, or the visual specification 355 of one or more underground objects, or other data suitable for extracting one or more characteristic of underground objects, possibly accompanied by other data. The data communicated by the GPR unit can also comprise more than one type of data from the list presented above in this paragraph, with or without other types of data.

The data communicated by the GPR unit to the GPR expert are communicated via real-time communication link 780. The GPR expert receives the data from the GPR unit via a processor (not explicitly shown in the figure) that presents the data to the GPR expert as an image on the computer monitor 750 depicted in the figure.

In the illustrative embodiment of FIG. 7, the computer monitor 750 performs the functionality of wearable display unit 370 (although, of course, the computer monitor is not wearable). As such, the computer monitor shows a composite image similar to composite image 410 wherein the ground is shown as partially transparent and underground objects are made visible. In this illustrative embodiment, the GPR operator can use a computer mouse 740 to create additional computer-generated images to be added to the composite view. For example, in FIG. 7, the GPR expert has created annotation 760 that is a computer-generated image that identifies an underground object as a gas pipe.

In the illustrative embodiment of FIG. 7, the GPR unit is equipped with an omnidirectional camera 725 that is capable of simultaneously collecting multiple views of the surrounding environment in a plurality of directions. In FIG. 7, the GPR expert is depicted as using the computer mouse 740. By using the mouse, the GPR expert can select a particular view of the environment as collected by the multidirectional camera. In alternative embodiments, the GPR expert can have multiple monitors for simultaneously viewing multiple view of the environment, and the GPR expert can use other input devices for selecting views or creating annotations or other computer-generated images

In some embodiments of the present invention, data from the GPR unit are stored in a storage medium along with annotations from the GPR expert. The data can be later retrieved to obtain information about underground objects. It is advantageous that the data comprises annotations by the GPR expert because a non-expert that retrieves the data can more easily identify underground objects thanks to the annotations.

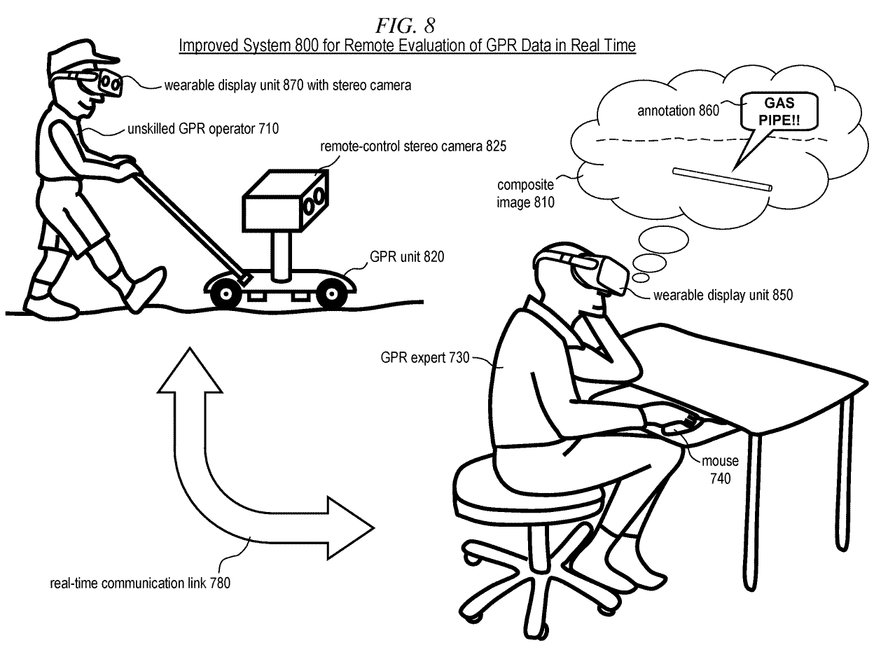

FIG. 8 depicts an alternative illustrative embodiment of the present invention that is similar, in some respects, to the illustrative embodiment of FIG. 7, and different in other respects. In this illustrative embodiment, the computer monitor 750 is replaced by wearable display unit 850, which is worn by the GPR expert 730. As in FIG. 7, the GPR expert is located remotely, relative to the site where the GPR unit is operated, and sees a composite image 810 of the environment surrounding the GPR unit 820. In this embodiment, the GPR expert sees the composite image via the wearable display unit 850.

In the illustrative embodiment of FIG. 8, the camera mounted on the GPR unit is not an omnidirectional camera. The camera is remote-control stereo camera 825, which is capable of collecting stereoscopic images of the environment. The stereoscopic images make it possible for the GPR expert to see realistic images of the environment via wearable display unit 850.

In the illustrative embodiment of FIG. 8, the remote-controlled camera can be remotely controlled by the GPR expert. For example, the GPR expert can control the camera via the mouse 740. The remote-controlled camera is equipped with motors that can move it so as to change the direction in which it takes pictures. The GPR expert can control the camera, as desired, so as to view the environment from different angles and points of view.

In alternative embodiments of the present invention, the GPR expert does not control the remote-controlled camera via the mouse. Instead, the wearable display unit 850 is equipped with sensors for sensing the position of the head of the GPR expert. Data about the position of the head are communicated to the remote-control stereo camera which turns itself to reproduce the head movements of the GPR expert. In such embodiments, the GPR expert can move his/her head in a natural way to view the environment from different angles and points of view.

Some variants of this illustrative embodiment are also depicted in FIG. 8. In particular, the unskilled GPR operator 710 is depicted as wearing a wearable display unit 870 equipped with a stereo camera. Embodiments of the present invention are possible wherein this feature is present in addition to, or instead of the remote-control stereo camera 825. In such embodiments, the unskilled GPR operator sees the surrounding environment in a natural way because the stereo camera associated with wearable display unit 870 captures the images that he/she would see naturally, and those images are displayed by display unit 870 for the benefit of the operator.

An advantage of this variant embodiment is that, now, the GPR expert can select to see those images too, instead of seeing just the images captured by remote-control stereo camera 825. This way, the GPR expert can see exactly what the GPR operator sees. In some variant embodiments, the GPR expert can give instructions, explanations, or other types of information to the GPR operator, for example, via an audio channel that enables the GPR operator and the GPR expert to talk to one another.

Furthermore, the GPR expert can communicate information to the GPR operator by creating images and/or annotations that appear in the composite image seen by the GPR operator. The reverse is also possible, as that the GPR operator can, for example, use an input device to highlight items in the image seen by the GPR expert. The GPR operator can also use an input device to create annotations or other computer-generated images to be added to the composite image seen by the GPR expert.

In all variant embodiments illustrated by FIGS. 7 and 8, images, annotations, and other data generated as part of the GPR data-collection session can be stored for later retrieval. Stored data can comprise any data generated by the GPR unit, by the GPR operator or by the GPR expert, or other data as well.

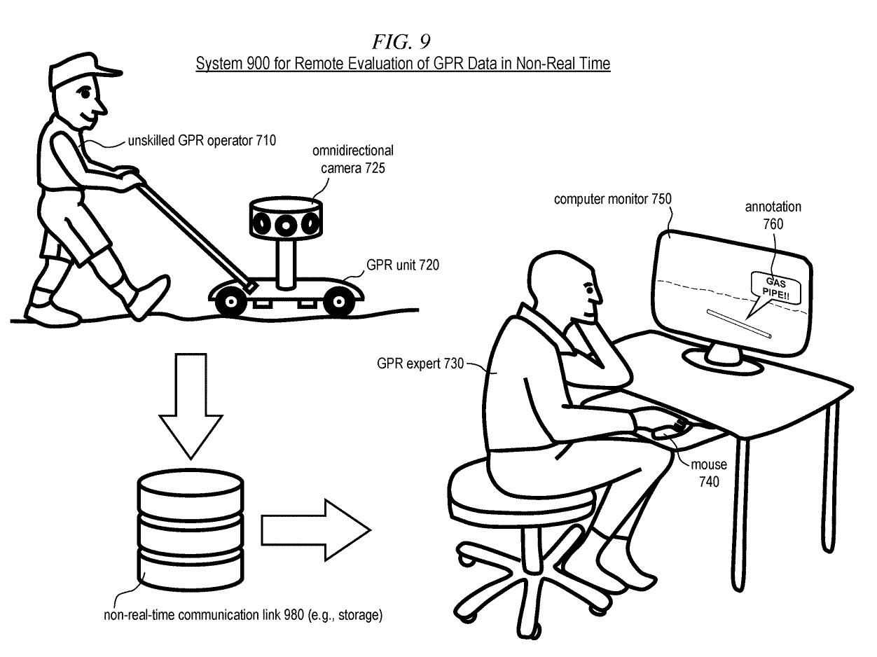

FIG. 9 depicts an alternative illustrative embodiment of the present invention wherein the GPR expert 730 interacts with the data collected by unskilled GPR operator 710 in non-real time; i.e., GPR expert 730 works on the GPR data at a later time, relative to when unskilled GPR operator 710 operated GPR unit 720 to collect the data. This is accomplished by storing the GPR data into a storage medium as it is collected, to be retrieved at a later time by the GPR expert. It is customary, in communication theory, to regard a storage medium used in this manner as a type of communication link. Such a communication link is known as a non-real-time communication link because it exhibits a large delay between the time when data is transmitted into the link, and the time when data is extracted. The delay means that the recipient of the communication cannot interact with the sender while the communication data is being generated. Of course, this is a unidirectional communication link.

In the illustrative embodiment of FIG. 9, the unskilled GPR operator completes a data-collection session without the benefit of live feedback or instructions from the GPR expert. All the data collected is fed into the non-real-time communication link 980. The collected data can comprise, for example and without limitation, the representation 335 of one or more reflected signals, or the indication 345 of the position of one or more underground objects, or the visual specification 355 of one or more underground objects, or other data suitable for extracting one or more characteristic of underground objects, possibly accompanied by other data. The data communicated by the GPR unit can also comprise more than one type of data from the list presented above in this paragraph, with or without other types of data, as in FIG. 7.

The collected data also comprises, in many embodiments, images captured by omnidirectional camera 725, and it can also comprise other types of data captured by other sensors or provided by the GPR operator.

At a later time, the GPR expert retrieves data from the non-real-time communication link, and, much like in FIG. 7, he/she examines the data by visualizing, on computer monitor 750, images of the environment, as captured by the camera 725. Via the mouse 740, and/or other input devices, the GPR expert can select for viewing different composite images of the environment wherein underground objects are shown as computer-generated images. As in FIG. 7, the GPR expert can create annotations or other computer-generated images to be added to the composite view.

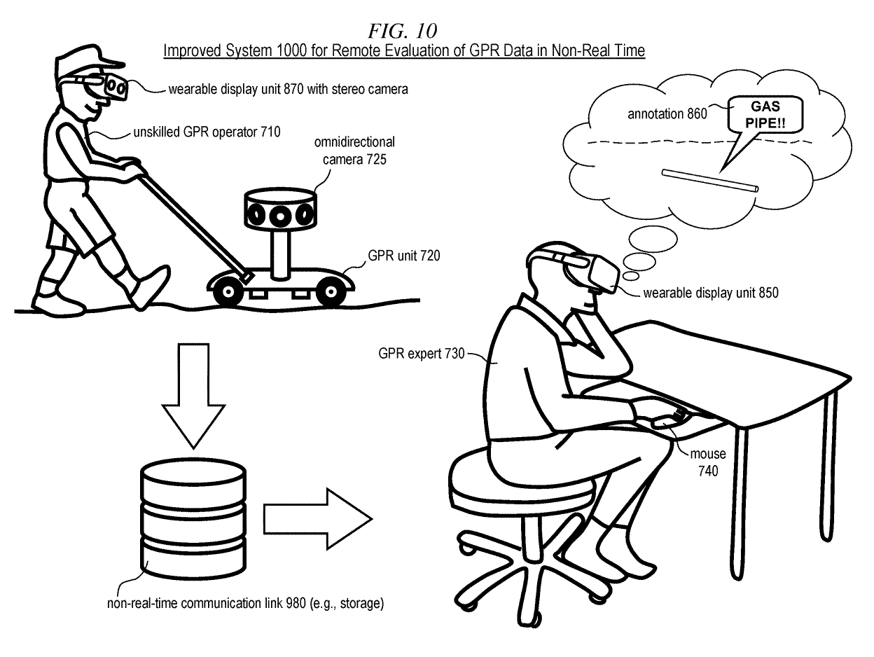

FIG. 10 depicts an alternative illustrative embodiment of the present invention that is similar, in some respects, to the illustrative embodiment of FIG. 8, and different in other respects. In this illustrative embodiment, as in FIG. 8, the computer monitor 750 is replaced by wearable display unit 850, which is worn by the GPR expert 730. However, in this figure, as in FIG. 9, the communication link is a non-real-time communication link. Many of the comments made in reference to the illustrative embodiment of FIG. 8 are still applicable, except that, with the communication link being unidirectional, the GPR expert is not able to provide instructions to the GPR operator or control the camera.

In this illustrative embodiment, the camera mounted on the GPR unit is an omnidirectional camera. The GPR expert is wearing wearable display unit 850, and is still free to move his/her head to adjust his point of view of the environment, but the image seen by the GPR expert in response to head movements is a computed image generated via software from the database of images captured by the omnidirectional camera. The software that generates the computed image combines multiple images from the omnidirectional camera to generate an image that matches the head position of the GPR expert as he/she turns his/her head.

As in other embodiments, via the mouse 740, and/or other input devices, the GPR expert can select for viewing different composite images of the environment wherein underground objects are shown as computer-generated images. As in other embodiments, the GPR expert can create annotations or other computer-generated images to be added to the composite view.

In the foregoing paragraphs, some illustrative embodiments of the present invention have been presented wherein visualization of a composite image occurs in real time, such that the image of the environment is a live image. However, it will clear to those skilled in the art, after reading this disclosure, how to make and use embodiments of the present invention wherein the composite image is based on data collected at an earlier time, as illustrated, at least in part, in FIGS. 9-11. In some such embodiments, a GPR unit is used at some point in time to collect data about hidden objects. Data about and images of the surrounding environment can also be collected at the same time or at a different time. All such data and images are stored in a storage medium. In such embodiments, generating a composite image that superimposes images of hidden objects on images of the environment is performed at a later time based on the stored data and images. If enough data and/or images are collected about the environment, it is possible to use virtual-reality techniques to allow a viewer to experience a realistic view of the hidden objects in the environment that is entirely based on stored data, even as the viewer is allowed to freely move around in the virtual environment.

In some embodiments of the present invention that are based on stored data, data about hidden objects and the objects' relationship to the environment are stored in a storage medium. In such embodiments, the stored data comprise the positions of objects relative to a reference frame, and/or the dispositions of objects relative to the reference frame. Other data about the environment such as images of the environment might or might not be stored. However, enough data about the environment are stored to make it possible, at a later time, to reconstruct the relationship of the reference frame to the environment. For example, in embodiments that use image processing for localization, enough images of the environment are stored to enable accurate localization.

Such data are, of course, based on measurements collected with a GPR unit at an earlier time. When such data are collected, real-time embodiments of the present invention such as illustrated in FIGS. 4 and 6 might or might not be used. In any case, the stored data must be sufficient for a processor such as object processor 340 to reconstruct, at a later time, information about position and other characteristics of the hidden objects relative to the reference frame.

Such embodiments are useful, for example, for a viewer that goes back, at the later time, to the environment where the GPR measurements were collected. With such embodiments, the viewer can wear wearable display unit 370 in the environment. The wearable display unit uses a localization system to estimate its own position and orientation in the environment relative to the same reference frame that was used when collecting the stored GPR data. For example, and without limitation, if image processing was used for localization at the time of collection of the GPR data, stored images of the environment can be compared to live images to reconstruct the relationship of the reference frame to the environment.

In general, such embodiments of the present invention use a localization system that enables reconstruction of where hidden objects are, relative to the environment, based on stored data. In such embodiments, a composite image is generated wherein images of hidden objects are visible in their accurate positions. The composite image is displayed for the viewer by wearable display unit 370.

The advantage of such embodiments is that a GPR crew can perform GPR measurements at one time, while, for example, a construction crew can perform construction activity at later time. In the prior art, this is often accomplished by the GPR crew placing markers, such as, for example, spray-paint markers, on various surfaces to indicate the location of hidden objects. However, this method is prone to errors as the paint markers might fade or be misinterpreted. Also, in many jurisdictions, marking surfaces with spray paint is not allowed. Embodiments of the present invention such as those described in the previous paragraphs, can include “virtual spray-paint markers” among the stored data. When the construction crew arrives, they can wear wearable display units that visualize both the hidden objects and the virtual spray-paint markers. For example, a backhoe operator might wear a wearable display unit while operating the backhoe for digging in an area with hidden objects that must be avoided. The composite image displayed by the display unit can show the hidden objects and the virtual paint marks to guide the digging. As an extra feature, in some embodiments of the present invention, a camera monitors the movements of the backhoe scoop and sounds an alarm if the backhoe operator digs too close to an object that should be avoided. In other embodiments, the backhoe can be automatically stopped before damage is caused to such an object.

The virtual paint marks are but one type of annotations that can be added to composite images. It will be clear to those skilled in the art, after reading this disclosure, how to make and use embodiments of the present invention wherein some activities associated with such embodiments are performed at the same time, or at different times. For example, and without limitation, in some embodiments, a GPR operator can collect GPR data in an environment at a first time. The collected data can be stored in a storage medium.

Further in such embodiments, an expert can visit the environment at a second time, and can examine the stored data through a wearable display unit 370 that displays composite images in accordance with the present invention. The expert can place virtual paint marks at certain places. More generally, the expert can generate annotations. Virtual paint marks can be regarded as a type of annotation that is associated to a position in space. In general, annotations can be associated to positions in space, or to objects, whether hidden or not, or to any other types of items, or can be not associated with anything in particular.

An advantage of the present invention is that annotations can be much more flexible than simple virtual paint marks. Annotations can comprise text, images, audio, or any other types of annotations that can be stored electronically using methods well know in the art. Annotations can also be edits to the stored GPR data. For example, the expert might decide to delete images of hidden objects that are not relevant or significant, or might decide to enhance images of important objects. All the annotations generated by the expert, and any other pieces of information that the expert might want to provide, are added to the stored GPR data.

Further in such embodiments, a construction crew can visit the environment at a third time. Through wearable display units, the construction crew can view composite images that include the stored GPR data and annotations provided by one or more experts. The construction crew can then proceed to perform their assigned tasks in accordance with the expert instructions, even though no experts are present at that third time.

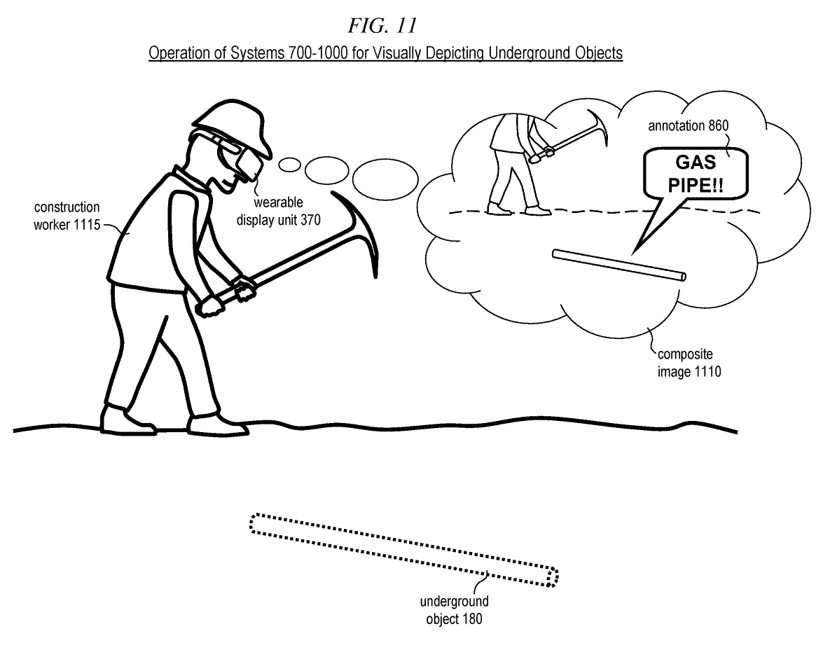

FIG. 11 illustrates how embodiments of the present invention can be used to advantage for visually depicting underground objects for the benefit of users other than GPR unit operators or GPR experts. The figure depicts a construction worker 1115 ready to start digging in the ground at a construction site. At an earlier time, the site was examined via one of the embodiments of the present invention as described in previous paragraphs. Also at an earlier time, underground objects were labeled by a GPR expert with annotations and/or warnings or other instructions as described above in accordance with embodiments of the present invention. For example, the annotation 860 depicted in the figure to identify an underground object as a gas pipe can be regarded as a type of virtual paint mark.

The construction worker is wearing a wearable display unit 370 that has access to data collected, at one of the earlier times, by a GPR unit. The data also comprises, data about underground objects as described above, as well as annotations, virtual paint marks and other data provided by one or more GPR experts. Through the wearable display unit, the construction worker sees a composite image 1110 that comprises a natural image of the surrounding environment as well as computer-generated images of underground objects and annotations. In the composite image, the ground appears partially transparent, and underground objects are visible in their correct position underground. Annotations provide information to the construction worker that enable him/her to take appropriate action to avoid hazards and undesired damage to the underground objects while digging.

It will be clear to those skilled in the art, after reading this disclosure, how to make and use embodiments of the present invention wherein some or all of the various activities associated with such embodiments are performed at different times based on live data or on stored data or on a combination of live and stored data. It will also be clear that some activities can be performed in the environment where GPR data are being collected or were collected earlier, while other activities can be performed elsewhere. For example and without limitation, in some embodiments, an expert that generates annotations at the second time can do so entirely based on stored data and without actually visiting the environment. In such embodiments, it can be advantageous for the stored data to comprise an extensive set of images of the environment. Such images can be collected together with the GPR data at the first time. The expert can then examine the stored data using virtual reality techniques that enable him/her to experience the environment as needed to generate annotations.

It is to be understood that this disclosure teaches just one or more examples of one or more illustrative embodiments, and that many variations of the invention can easily be devised by those skilled in the art after reading this disclosure, and that the scope of the present invention is defined by the claims accompanying this disclosure.

1. A system based on ground-penetrating radar (GPR) that visually depicts objects hidden by a surface, the system comprising:
a GPR unit that is moved along a path on the surface, wherein the GPR unit transmits a first radio signal and receives a second reflected radio signal, wherein the second reflected radio signal comprises one or more reflections of the first radio signal caused one or more of the objects hidden by the surface;
a first processor that receives a representation of the second reflected radio signal and, based on the representation, generates a description of at least one of the hidden objects, wherein the description comprises an indication of a position of the at least one hidden object;
a second processor that receives the description of the at least one hidden object and generates a visual specification of the object relative to an environment, wherein the visual specification comprises a specification of the position of the object relative to the environment; and
a display subsystem that receives the visual specification and generates a composite image that combines an image of the environment and an image of the object, wherein the image of the object is placed, relative to the image of the environment, in accordance with the specification of the position of the object provided by the visual specification.

2. The system of claim 1 wherein the display subsystem comprises a wearable display unit wherein the part of the composite image that is the image of the environment is an actual image of a surrounding environment viewed through a material that is transparent, at least partially.

3. (canceled)

4. The system of claim 1 wherein the display subsystem comprises an electronic display unit that generates the entire composite image electronically, wherein the image of the environment is based on an image captured by a camera.

5. The system of claim 4 wherein the camera is part of the display subsystem and the image of the environment is a live image.

6. The system of claim 1 further comprising a wireless communication link that interconnects any two of the GPR unit, the first processor, the second processor, or the display subsystem.

7. (canceled)

8. The system of claim 6 wherein the display subsystem is located remotely relative to the GPR unit.

9. The system of claim 1 further comprising a non-real-time communication link that interconnects any two of the GPR unit, the first processor, the second processor, or the display subsystem.

10. (canceled)

11. The system of claim 1 further comprising a data-storage device that stores data;
wherein the stored data comprises, at least in part, one or more of (i) the representation of the second reflected radio signal, (ii) the description of the at least one hidden object, (iii) the visual specification of the object relative to the environment.

12. The system of claim 11 wherein the display subsystem generates the composite image based, at least in part, on data stored in the storage device.

13. The system of claim 12 wherein the display subsystem generates the composite image based, at least in part, on data stored in the storage device.

14. (canceled)

15. The system of claim 4 wherein the image of the environment is derived from a stored image retrieved from a storage medium.

16. The system of claim 1 further comprising a localization subsystem that generates an estimate of a position of the GPR unit;
wherein the indication of the position of the at least one hidden object is based on the estimate of the position of the GPR unit; and
wherein the estimate of the position of the GPR unit is relative to a reference frame.

17. The system of claim 16 wherein the reference frame comprises one or more of (a) a satellite that transmits a radio signal, (b) a global navigation satellite system (GNSS) satellite, (c) a global positioning system (GPS) satellite, (d) a transmitter of a radio-signal, (e) a source of a sound signal, (f) a source of an ultrasonic signal, (g) a visual marker, (h) an augmented-reality (AR) marker, (i) a visible marker placed by an operator of the system, (j) a visible pattern on the surface, (k) a grid on the surface, (I) a detectable feature of the surface, (m) one or more objects in the environment.

18. The system of claim 16 wherein the localization subsystem comprises a camera adapted to capture an image of the GPR unit while it is moved along the path on the surface, and wherein the estimate of the position of the GPR unit is based, at least in part, on the image of the GPR unit.

19-21. (canceled)

22. The system of claim 1 wherein the composite image further comprises an image of the path;
wherein the image of the path comprises at least one of (a) an image of a portion of the path that the GPR unit has followed in the past, and (b) an image of a portion of the path that the GPR unit is expected to follow in the future.

23-30. (canceled)

31. A method for visually depicting objects hidden by a surface and detected via ground-penetrating radar (GPR), wherein the GPR unit is moved along a path on the surface, the method comprising:
transmitting, by the GPR unit, a first radio signal;
receiving, by the GPR unit, a second reflected radio signal, wherein the second reflected radio signal comprises one or more reflections of the first radio signal caused one or more of the objects hidden by the surface;
receiving, by a first processor, a representation of the second reflected radio signal;
generating, by the first processor, a description of at least one of the hidden objects, wherein the description comprises an indication of a position of the at least one hidden object, and wherein the description is based on the representation of the second reflected radio signal;
receiving, by a second processor, the description of the at least one hidden object;
generating, by the second processor, a visual specification of the at least one hidden object relative to an environment, wherein the visual specification comprises a specification of the position of the object relative to the environment;
receiving, by a display system, the visual specification; and
generating, by the display system, a composite image that combines an image of the environment and an image of the object, wherein the image of the object is placed, relative to the image of the environment, in accordance with the specification of the position of the object provided by the visual specification.

32. The method of claim 31 wherein the first processor and the second processor are the same processor.

33. The method of claim 31 wherein at least one of the first processor and the second processor is part of at least one of the GPR unit and the display system.

34. The method of claim 31 wherein the display system comprises a wearable display unit wherein the part of the composite image that is the image of the environment is an actual image of a surrounding environment viewed through a medium that is transparent, at least partially.

35. (canceled)

36. The method of claim 31 wherein generating the composite image comprises:
combining, electronically, the image of the environment and the image of the object; and
generating, by an electronic display unit, the entire composite image;
wherein the image of the environment is based on an image captured by a camera.

37. The method of claim 36 wherein the camera is part of the display system and the image of the environment is a live image.

38-39. (canceled)

40. The method of any one of claim 31 further comprising retrieving the image of the environment from a storage medium.

41. The method of claim 31 further comprising generating, by a localization system, an estimate of a position of the GPR unit;
wherein the indication of the position of the at least one hidden object is based on the estimate of the position of the GPR unit; and
wherein the estimate of the position of the GPR unit is relative to a reference frame.

42. The method of claim 41 wherein the reference frame comprises one or more of (a) a satellite that transmits a radio signal, (b) a global navigation satellite system (GNSS) satellite, (c) a global positioning system (GPS) satellite, (d) a transmitter of a radio-signal, (e) a source of a sound signal, (f) a source of an ultrasonic signal, (g) a visual marker, (h) an augmented-reality (AR) marker, (i) a visible marker placed by an operator of the system, (j) a visible pattern on the surface, (k) a grid on the surface, (I) a detectable feature of the surface, (m) one or more objects in the environment.

43. The method of claim 41 wherein generating, by the localization system, the estimate of the position of the GPR unit further comprises capturing, by a camera, an image of the GPR unit while it is moved along the path on the surface, and wherein the estimate of the position of the GPR unit is based, at least in part, on the image of the GPR unit.

44-46. (canceled)

47. The method of claim 31 wherein generating, by the display system, the composite image, comprises generating an image of the path;
wherein the image of the path appears in the composite image; and
wherein the image of the path comprises at least one of (a) an image of a portion of the path that the GPR unit has followed in the past, and (b) an image of a portion of the path that the GPR unit is expected to follow in the future.

48-54. (canceled)
